(19) United States
(12) Patent Application Publication
(10) Pub. No.: US 2010/0188931 A1
(43) Pub. Date: Jul. 29, 2010

(54) DESIGN AND METHOD FOR IMPROVING THE PERFORMANCE OF SUBMARINE AND OTHER WATER CRAFT SONAR SENSORS, ARRAYS AND/OR HYDROPHONES

(76) Inventor: Mark Noonan, New Canaan, CT (US)

Correspondence Address: HARNESS, DICKEY, & PIERCE, P.L.C, 7700 Bonhomme, Suite 400, ST. LOUIS, MO, 63105, US

(21) Appl. No.: 12/693,416

(22) Filed: Jan. 25, 2010

Related U.S. Application Data
(60) Provisional application No. 61/202,103, filed on Jan. 27, 2009.

(51) Int. Cl. G01S 15/00; B66C 23/04

(52) U.S. Cl. 367/87; 212/349

(57) ABSTRACT

Disclosed herein are exemplary embodiments of devices to attach to submarines or other water craft to enable a sonar array to function better at higher water speeds. When operated, the devices slow down or fully offset the mounted array's (hydrophones' or arrays') relative water speed and reduce the water friction noise on the array, allowing it to function more optimally. In an exemplary embodiment, a device includes a telescoping boom that can be alternately retracted and extended to provide cycles (or rotates to provide similar cycles for any one array) of higher performance reception and “hearing” by the array, as its relative water speed is reduced or offset. The device can be mounted on the external surface of the hull to “retrofit” existing craft or built so that in the telescoping embodiment, the housing can be fully retracted and hidden from view and otherwise protected more fully when not in use.

### CROSS-REFERENCE TO RELATED APPLICATION

This application claims the benefit of U.S. Provisional Application Ser. No. 61/202,103 filed Jan. 27, 2009, the entire disclosure of which is incorporated herein by reference in its entirety.

### FIELD

The present disclosure generally relates (but not exclusively) to devices that can be used to reduce the noise generated by water flowing over a hydrophone or hydrophone array. It also relates to designs to mount hydrophones and smaller arrays on movable housings or mounts and methods to reduce the water flow noise over the hydrophones using embodiments of designs that can direct and improve signal identification from the main sonar arrays when submarines or other water craft that use such sonar systems, are traveling at “above-tactical” speeds.

For purposes of this document, the terms, submarine, boat, bow, etc are just examples and not intended to be limiting of relative placement of equipment or structures or methods being discussed. Further, the term sonar may collectively refer to the hydrophones or other components and vice versa.

### BACKGROUND

This section provides background information related to the present disclosure which is not necessarily prior art.

It is understood that sonar technology currently in use in submarines and other underwater craft (as well as other water craft in general) is adversely affected as water speed is increased. Water rushing past and over the sonar sensor interferes with the reception by generating increasing levels of noise—over the sensor cover or outer shell.

Sonar arrays and hydrophones are built in or mounted on many parts of the boat (conventional, submarine, etc.) with each array design optimized to capture signals within a range of wave lengths. For example the spherical array, mounted on the front of many submarines, is designed for broadband detection and for active sonar reception (a ping is generated so that the echo can be received by the sonar). While a high frequency array is mounted on the sail.

While signatures can be detected, discerning the signature or pattern from noise can be very difficult, if near impossible when the submarine is operating above tactical speed (speeds defined as, above which, one or more of water noise, vessel vibration, engine noise, or cavitation significantly impair quiet craft operation and effective sonar functioning). Not only are submarines emitting much more noise when they travel at higher speeds, but they are concurrently less able to learn from what their sonar is picking up amid the noise induced by the high relative water speed of the sensors and the resulting noise induced that impairs sensor and overall sonar detection performance.

As some submarine-related technology is classified (while much is in the public domain to some degree), shielded sensors, computer filters and algorithms are a few of the technologies to reduce the “blindness” due to this sonar listening degradation at high speeds.

### SUMMARY

This section provides a general summary of the disclosure, and is not a comprehensive disclosure of the full scope or all of its features of the subject of this filing.

Disclosed herein are exemplary embodiments of devices to attach to submarines or other water craft to enable a sonar array to function better at higher water speeds. When operated, the devices slow down or fully offset the mounted array's (hydrophones' or arrays') relative water speed and reduce the water friction noise on the array, allowing it to function more optimally. In an exemplary embodiment, a device includes a telescoping boom that can be alternately retracted and extended to provide cycles (or rotates to provide similar cycles for any one array) of higher performance reception and “hearing” by the array, as its relative water speed is reduced or offset. The device can be mounted on the external surface of the hull to “retrofit” existing craft or built so that in the telescoping embodiment, the housing can be fully retracted and hidden from view and otherwise protected more fully when not in use.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a device according to an exemplary embodiment, and illustrating the device assembled and installed on the bow and below the bow of a boat or submarine (in one of two or more possible locations, with the craft merely drawn as a simplified partial silhouette)—other possible placements on the mast etc. are not drawn.

FIG. 2 is a similar side view of a device similar to the embodiment in FIG. 1, but the housing (or non-collapsing portion) installed between an inner and outer hull in both retracted and extended position (dotted lines showing the array extended and constructed in only 3 sections (i.e., two telescoping section), though an exemplary embodiment could have more than two sections to increase the range of retraction and time window for cleaner “listening”;

FIG. 3 is a closer view of side view of the device shown in FIGS. 1 and 2 shown with 3 telescoping sections (i.e., 2 retracting sections) with the array mounted on the end;

FIG. 4 is a cutaway view of side view of the device shown in FIGS. 1 and 2 shown with 3 telescoping sections (i.e., 2 retracting sections) with the array mounted on the end—in the retracted position;

FIG. 5 is a side profile of various shaped arrays that would be mounted on the end of the telescoping array mount or arm.

FIG. 6 is an actual image of the inner hull in the bow of a Seawolf (SSN-21) submarine indicating possible locations to mount the telescoping DSS (of many alternative locations).

FIG. 7 is a side view close up of an alternative design of the DSS that mounts the sensor on a rotating tread where the tread is driven by a motor or other means.

FIG. 8 is a further or related embodiment to that in FIG. 6, where the shape of the tread housing or frame is designed so as to more cleanly split the water flow with a thin but solid edge in order. However, the rotating tread itself is similar in basic function and design.

### DETAILED DESCRIPTION

Example embodiments will now be described more fully with reference to the accompanying drawings.

As disclosed herein, a dynamic sonar sensor (“DSS”) involves a mechanical technique to slow the relative water speed of the hydrophone, reducing flow noise and increasing the hydrophone's effectiveness.

Generally, hydrophones and sonar arrays are mounted on the submarine in such a way so that they move at, or very close to, the same speed relative to the water as the submarine (with the notable exception of towed arrays during their deployment and retraction phases). As the boat accelerates relative to the water, so does the sonar sensor. As the sensor moves through the water faster, flow noise and submarine self noise increases making signal detection increasingly difficult.

The principal behind the dynamic sonar sensor is to reduce or eliminate the noise created by the water rushing over the sensor (turbulence, cavitations and friction) by reducing a major source of turbulence and other noise-generating fluid dynamics on and around the sensors. This is done generally, not by shielding the sensor but by changing the sensor's relative water speed from that of the submarine. Of course, it is generally the submarine and not the water that is moving, though the relative water speed is typically mostly due to the submarine/sensor forward speed—clearly some of the relative water speed may be due to water currents. But in any case, generally, engine or other thrust is needed to establish and maintain relative water speed. Ground speed in this technology is not particularly relevant.

Simply put, the various embodiments of this invention are designed to reduce or offset the relative water speed of a sensor, and establish at least intervals where the relative water speed of the sensor is reduced so it will be less than that of the craft, and even potentially near or at zero. The sensor whose relative water speed is being reduced, might be significantly smaller and less capable than, for example, either the domed array, though it might be located near or on the bow of the craft, or possibly in other locations. Thus, the reduced relative water speed enables the sensors to perform at least sufficiently to identify sounds, sound patterns, etc. sufficiently to guide the data search making the analysis of the noise-filled readings from the main sensor arrays more effective—much like pointing out a well camouflaged target in a large field of vision than focusing the search for more detail that would be otherwise obscured by the large volume of “data” (possibly mostly noise as the water speed increases).

Once identified, the task of ignoring the “noise” of the camouflage is greatly facilitated, as then the vast majority of noise does not have to be identified and only the target sounds or patterns must be searched for and enhanced to re-establish acceptable intelligence/data gathering and gather meaningful, timely data from the sensors, despite the extra noise induced by the higher relative water speed.

Towed arrays attempt to place the sensor in less turbulent areas behind the submarine, but alone do not address the excess noise issue discussed above. Certainly these arrays can be used while the array is being either deployed or retracted—and likely somewhat more effective while being deployed as the relative water speed is less during deployment. Though in both cases, the array still suffers from turbulence and noise generated by the submarine, engines, etc (and during deployment the array is closer to the craft's turbulence, engines, and propeller turbulence generally). However, towed arrays have mechanical limitations, thus limiting their use to certain tactical situations. Also they cannot be deployed at high speeds due largely to the significant associated water friction. Generally, towed arrays provide degraded functionality until fully deployed and stable in the water (and moving at the same relative water speed as the craft), and can suffer performance degradation when the boat or craft is turning and are generally not deployed at higher speeds.

Among possible implementations, DSS can be implemented on an elongated probe or other movable device protruding out the front or other area of the submarine, or on a device that moves along the side of the submarine, on a device that is released from the submarine and then recaptured or not. While we are discussing DSS for submarines, this technique can also be applied to surface other types of ships or craft, including, for example unmanned, such as torpedoes.

The DSS uses a dynamic sensor instead of fixed or relatively fixed sensors. For purposes of this document, the terms, submarine, boat, bow, etc are just examples and not intended to be limiting of relative placement of equipment or structures or methods being discussed.

In one embodiment the sensor (or sensors) is placed on the tip of an arm assembly that extends forward from the bow (it may be more effective directly ahead—off the nose or bow—of the submarine or craft, though it can be implemented in other positions such as the mast, but could be mounted in other positions as well). The sensor arm and sensor assembly is designed in one of two or more ways. Two designs are intended to enable the sensor to be retracted at a speed that reduces its relative water speed—in the opposite direction of the boat or craft (or extended if the boat is traveling in reverse).

For example, if the boat is traveling at 40 knots relative water speed, and the sensor arm is retracted at 20 knots, then the sensor's relative water speed would be 20 knots—a speed that would generally enable much improved reception, even if the sensor array was smaller than the full or main arrays. It is intended (but not required), that the DSS array would be smaller and designed to identify sounds and other signal patterns to then guide the extraction of the relevant information captured by the full, main sensor arrays that have been “blinded’ by the excess water noise on the sensors.

In general, the array could provide cycles of reduced reception, by repeatedly retracting and extending the sensor from its mechanical housing—in one direction as relative water speed of the sensor is reduced, the sensor would gather “clean” data, and then gather “clean” data again, after it has extended again and begins another retraction. Thus, sensor would provide cycles of cleaner data to guide the main arrays.

For example, in one embodiment, the hydrophones and array would be mounted on a telescoping boom or arm that might be constructed of two or more concentric sections. Such boom or arm(s) when fully extended would be two times or more longer than it's length during its retracted state. The boom could be water (for example sea water or water from around the boat), oil, or other similar materials filled to facilitate extension and retraction in quick cycles using hydraulic pressure and reduced mechanical noise introduced by the boom operation. There may also be means to use magnetic, hydraulic or other devices and constructions to reduce friction and other mechanical noise related to the retraction of the boom and sensor in order to improve the sensor performance by eliminating background noise.

The boom or arm assembly would in one embodiment mount much like a surface mount that could be used to retrofit existing boats, with only the wiring and connections extending inside the outer hull. However, it could be also mounted partially or fully inside the outer hull, between the inner and outer hulls, as well as in other configurations.

In other embodiments, the boom or arm and the housing (fully retracted unit) would be all or partially mounted in the space between the inner and outer hull, and in its optimal embodiment (for security as well as other related reasons) would be flush with the outer hull when fully retracted.

In one exemplary embodiment the boom or arm would extend approximately 20-30 feet by employing 2 to 4 telescoping sections and would retract to a contracted length of approximately 10-20 feet. Generally, longer sections and extensions (and longer fully retracted housing) could be used when the unit is mounted in the space between the inner and outer hull, so it would project outside the outer hull when fully retracted—and shorter for surface mounting on or partially extending beyond the outer hull.

Thus, the boom or arm would be extended and then retracted at a rate or speed determined to reduce or eliminate its relative water speed to maximize data gathering (possibly balancing the tradeoff of reducing relative water speed vs. the noise generated from the operation of the boom, arm or other housing being retracted). For example, reducing the relative water speed of the sensor to zero might not be preferable as it would reduce the “listening window” and gather less information. Rather, a retraction rate, for example, to reduce the relative water speed to, for example, below 20 knots might be sufficient to optimize listening during this retraction cycle. Such a boom or arm when mounted on a submarine traveling at 40 knots and retracted such that the relative water speed of the boom or arm was 20 knots, could gather roughly 6,000-18,000 data samples on each retraction (though, of course, would vary with the size of the sensor and array, the length of the retraction distance and other factors).

Further, the sensor boom or arm would be continuously or repeatedly cycled through retraction and extension phases, and thus able to listen, during for roughly 50% or possibly more of the time in alternating phases of high and low relative water speed (corresponding with extension and retraction of the sensor array boom or arm). If the extension speed, were, for example, greater than the retraction speed, this could provide listening phases over 50% of the time. Conversely it could be lower if the extension speed were slower.

The sensor can only remain in motion at any speed in this retraction phase of its cycle for a finite period of time (even if the sensor were trailed behind the submarine similar to a towed array where ‘line’ is continuously released at the relative water speed, it will reach the end of its ‘travel range’). Two principal applications that derive from this concept are described below. Both can be built with one or more sensors incorporated into the system.

Another (though not the only other) embodiment of the DSS is to use a “conveyor belt” type design where a rotating wheel (or oblong, oval or similarly rounded shape) or belt is attached on a fixed post to mount the sensors (as opposed to retracting arm or boom as described in other embodiments, although the embodiments or features of them might be combined). If the belt or disc is rotated at a speed to ensure that the attached sensor or sensors are moving at the relative water speed, then as any one of the sensors begins its portion of the ‘rotation’ back towards the submarine, it would be moving at exactly the relative water speed but, thus again creating a zero relative water speed—and optimal sensor reception. Of course any speed of rotation would reduce the relative water speed of the sensor or sensors.

As an example of additional variations, a projectile containing a receptor (tethered or not) could be launched ahead of the submarine then stop and allowed to drift until the submarine caught up. During the period where the projectile is stationary, or in lower relative water speed, and before the submarine caught up with it the receptor in the projectile would have relatively low or no relative water speed and could pass the received signals (along cable or short distance wireless communication) back to the submarine. Then it would be retrieved by cable or left as the submarine, through its forward speed, approached the relatively stationary projectile. This latter variation suffers from the added noise created when launching the projectile.

Various exemplary aspects of the present dynamic sonar sensor disclosure are provided. Further aspects relate to methods of reducing sensor(s) relative water speed to permit them to be more functional when the craft to which they are attached is traveling at speeds that would otherwise degrade sonar performance and signature identification. Additional aspects relate to designs and methods of building the housing and mechanisms for the DSS to reduce mechanical noise during the DSS' operation—towards the same objective of improving overall sonar performance at any, but especially, higher relative water speeds of the craft.

Exemplary embodiments discussed below can be constructed to fit varying sized crafts and in attached or secured in various locations, though the most optimal are where the water is undisturbed by the craft—generally in the exemplary embodiments near or around the bow or front of the craft.

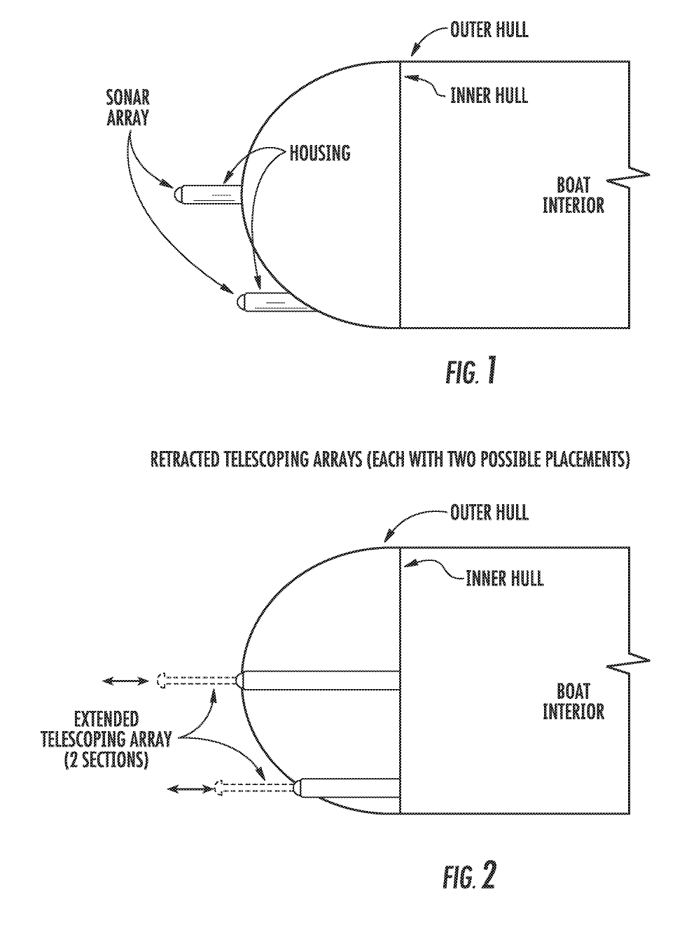

In one exemplary embodiment, with reference to FIG. 1, the DSS array is mounted on the end section of a multi-sectional telescoping arm. The telescoping arm can be constructed in two or more sections. The preferred number of sections to this arm assembly will depend on the final size, materials, type of retraction drive and mechanism, but in one exemplary embodiment would have a retraction range of approximately 20 to 30 feet or more. With two or more retractable sections in the telescoping arm, the order of the retraction of the sections can vary in this method of operation, although in one exemplary method, it is anticipated that the largest diameter section would be retracted first and the smallest diameter section retracted last, both for ease of constructing the mechanical retraction mechanism and to reduce turbulence around the array. In another, the order would be reversed or in yet another, all sections retraction concurrently.

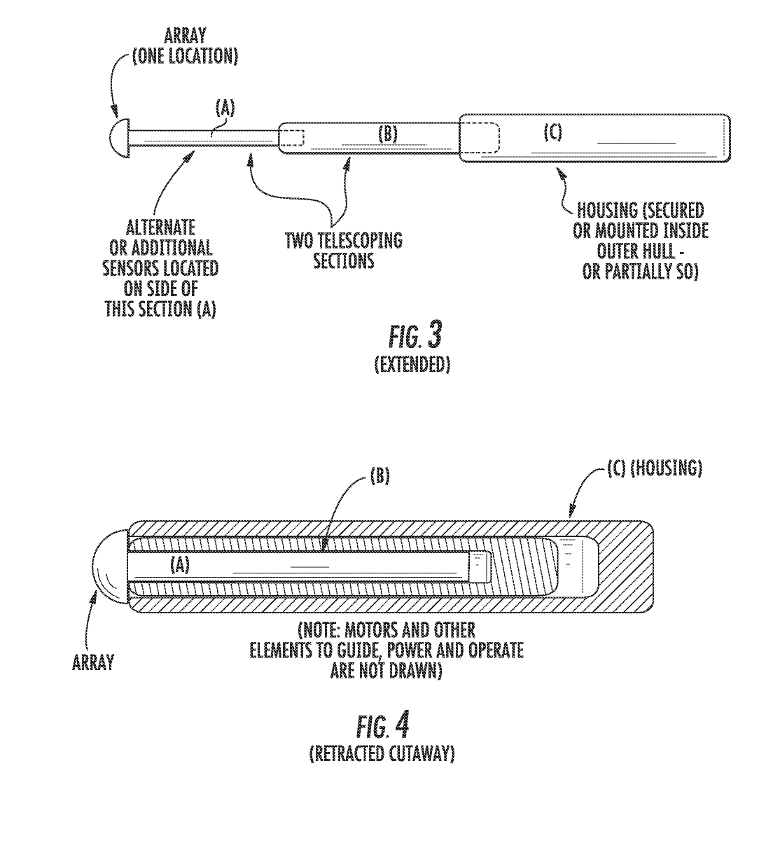

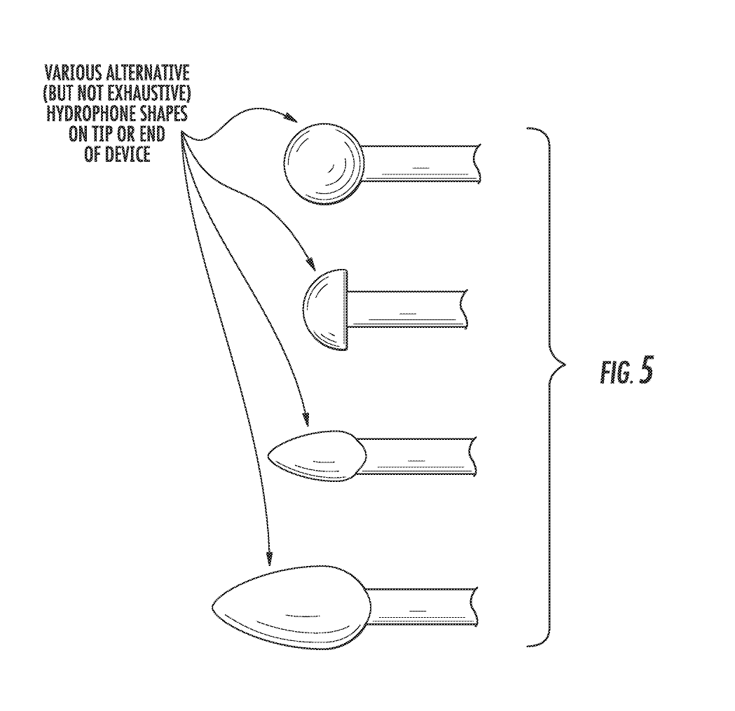

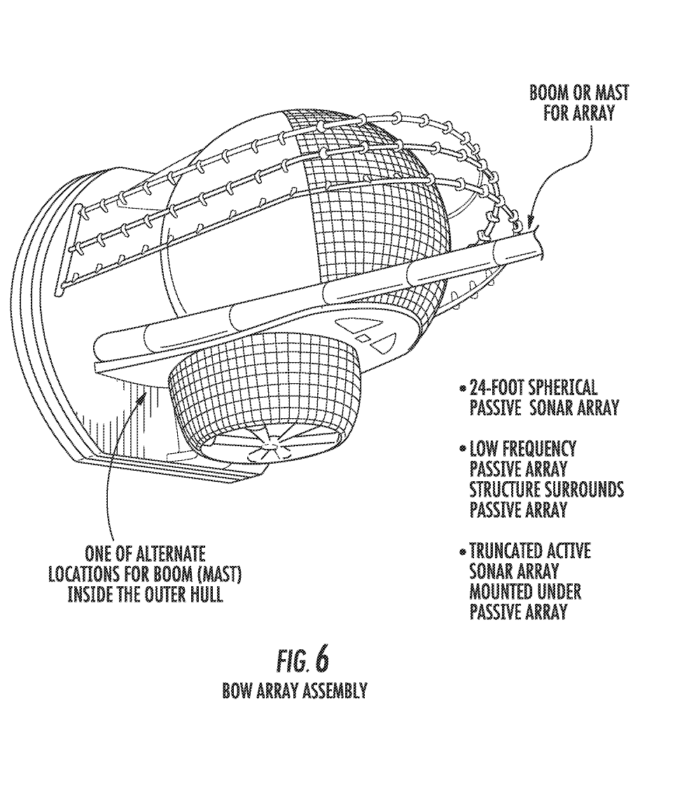

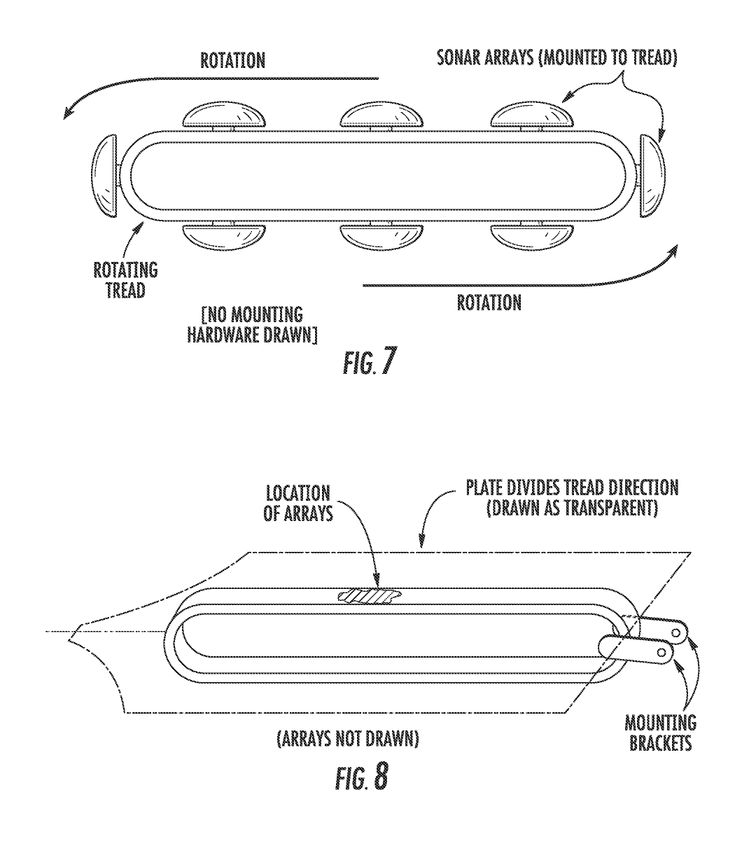

In a further aspect of the disclosure, the location of the sensor array on the telescoping arm in FIGS. 1 and 2 might vary and could be located on the tip and leading edge only, as drawn in FIGS. 1 and 2, or could also include elements of the array along the stalk or sides of the section labeled ‘A’ (and even possible on the other sections, ‘B’ and ‘C’ as available) on FIGS. 1 and 2, to provide a great surface area for the arrays, improving their performance in general.

In another related exemplary embodiment, the array would be retracted with each telescoping section being retracted simultaneously in order to reduce the speed (and thus resulting operational noise introduced) during the retraction phase, by minimizing the speed at which any single segment is retracted. For example, with three retractable sections all being retracted simultaneously, the speed of their retraction necessary to offset a given amount of the craft's relative water speed would be ⅓ of the speed of any one segment being retracted alone. And depending on the mechanism for retraction, and the impact of operational speed and resulting noise generation, there will be an optimal mix of operational speed versus the number of segments being operated that will minimize overall mechanical noise introduced by the retraction of the DSS array in general or specific to any given speed of retraction.

A further embodiment would use a liquid such as water (most likely sea water or water in which the craft is traveling) to drive the retraction and extension of the boom or arms in conjunction with one or more pumps to fill and remove water from the internal cavity of the boom or arms.

A further aspect of the disclosure is telescoping arm with multiple sections as described, where the extension and the retraction of the sections is driven by a series of electromagnets, or in combination with hydraulic drive to extend, but particularly, retract the array while minimizing mechanical noise from its operation. The retraction mechanism and method may also include fins or other protrusions from one or more of the telescoping sections that would be deployed to initiate and during the retraction phase. These fins or flaps would function similarly to air breaks or flaps on aircraft—increasing the profile temporarily during retraction phase to use water pressure to drive the retraction of the telescoping mechanism, or in conjunction with or mechanical means.

An additional aspect of the disclosed invention (as shown on the leading tip of the telescoping arm, as indicated in the drawings) is the shape of the array itself. The shape drawn in FIG. 1 is one of many possible designs that could be used. The semi-circular design shown in FIGS. 1 & 2, for example, might be more effective if the DSS is employed to virtually reduce the relative water speed of the array to near zero. But if in an implemented embodiment the optimal noise reduction and array functioning (balancing relative water speed, mechanical noise in the telescoping arm or boom, the length of the listening window) occurs at a meaningful relative water speed, then a more stream lined array would be more optimal that would create less water turbulence and eddies than for the design shown in FIGS. 1 & 2 (e.g., more elliptical shapes similar to a “football”, spheroid or prolate spheroid, etc.).

In another exemplary example, shown in FIG. 6, the DSS array is comprised of two or more arrays that are mounted on a rotating band or tread, whereby when the tread is rotated then at least one or more array mounted on the tread will be traveling in opposite direction of the relative water speed of the craft (thus, whose relative water speed would thus be reduced). By altering the speed of rotation of the band (or “treadmill”) the relative water speed of the various arrays can be controlled to minimize water noise on the arrays during their “retraction” phase, though with multiple arrays on the tread, there will be continuous listening capability with at least one array at all times (i.e., “listening” with reduced or zero relative water speed).

In another exemplary embodiment, with continued reference to FIG. 6 (of the rotating ‘treadmill’ design), the rotating band would be centered on a dividing plane such that water on one side of the plane would be separated and turbulence on one side would be somewhat separated to reduce the impact of turbulence and eddies in the water from impacting the water on the other side of the rotating tread. Thus on the side of the plane where the array was rotating so as to reduce or eliminate its relative water speed, there would be less turbulence, as the arrays and tread would be moving at a lower relative water speed. Thus by more effectively dividing the water flow on either side of the rotating DSS arrays, the more turbulent water on the side of the tread (where the array(s) were moving at a higher relative water speed) will be more insulated from the lower turbulence side of the DSS, where the arrays are in the “listening” phase (traveling at the lower or near zero relative water speed).

Alternative embodiments may include various combinations or components from one embodiment combined with components in others.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. An apparatus attachable to a submarine or other water craft, the apparatus comprising a boom or arm and the hydrophones or sonar array coupled to the boom or arm to enable the hydrophones and array to be transported through the water to offset all or some of the craft's relative water speed, in order to reduce the water noise impacting the performance of the array.

2. The apparatus of claim 1, wherein the boom or arm is constructed of several concentric and nesting generally tubular sections that can be mechanically driven to extend and retract.

3. The apparatus of claim 1, wherein a sonar array or hydrophone is mounted on the tip of boom or arm and can be retracted to offset some or all of the relative water speed of the craft to which it is attached.

4. The apparatus of claim 1, further comprising a base which can be mounted on the surface of the submarine or other craft or between the inner and out hull (and partially or fully enclosed between the hulls when fully retracted.

5. The apparatus of claim 1, wherein the apparatus is fit on the bow of the submarine or boat.

6. The apparatus of claim 1, wherein the apparatus is driven or operated with hydraulic pumps, using water from which the craft is in (or alternatively oil or other liquids).

7. An apparatus attachable to a submarine or other water craft, the apparatus comprising a rotating tread on which two or more sonar arrays are mounted

8. The apparatus of claim 7, wherein the sides of the tread are separated by a metal or other rigid material to separate the turbulence on one side of the array from the other side, where the array and tread are traveling in the opposite direction.

9. A method for mounting and transporting a sonar array or arrays, to reduce the arrays' relative water speed to enable higher performance from the array while the craft is traveling at higher relative water speeds.

10. The method of claim 9, wherein the retracting array is attached to the bow of the submarine or craft.

11. The method of claim 9, wherein the rotating tread is attached to the mast or other areas.
